(19) United States
(12) Patent Application Publication
(10) Pub. No.: US 2020/0278715 A1
(43) Pub. Date: Sep. 3, 2020

(54) OPERATING COMPONENT FOR A DEVICE WITH HIDDEN-TO-LIT PATTERN

(71) Applicant: MOTHERSON INNOVATIONS COMPANY LIMITED, London (GB)

(72) Inventors: Dean Caruso, Lonsdale (AU); Sam Thoday, Lonsdale (AU); Gary Dekievit, Lonsdale (AU)

(21) Appl. No.: 16/804,977

(22) Filed: Feb. 28, 2020

(30) Foreign Application Priority Data
Mar. 1, 2019 (DE) 10 2019 105 285.8

(51) Int. Cl. G05G 1/10; F21V 8/00

(52) U.S. Cl. CPC G05G 1/105; G02B 6/0031

(57) ABSTRACT

An operating component to operate a device includes a component body with a side face and as a front face arranged on the component body and being suited for being at least partly illuminated by at least one light source, a light guide made of clear and transparent material, and a reflector arranged in the component body, with the light guide receiving light from the light source and directing the light to the reflector arranged underneath the front face.

### CROSS-REFERENCE TO RELATED APPLICATION

This application claims the benefit of foreign priority to German Patent Application No. DE 10 2019 105 285, filed Mar. 1, 2019, which is hereby incorporated by reference in its entirety for all purposes.

### BACKGROUND

### 1. Field of the Invention

The present disclosure relates to operating component for a device with hidden-to-lit functionality and to a device including at least one of such operating components.

### 2. Related Art

Whitegoods, consumer goods and other devices provide functionality to users and differentiate from each other beside its functionality also by its appearance. It would be desirable to provide whitegoods, consumer goods and other devices differentiating from competitors. One method to create an attractive appearance is to use so-called hidden-to-lit knobs denoting knobs e.g. looking metallic in an off state, where some features, graphics, or pattern light up at some point during operation of the knob.

EP 2 074 238 B1 discloses such a hidden-to-lit knob as a cap for a display and/or control element, comprising a cap member for covering a light source and/or actuating a switch of an associated control element. A luminous area or projection area is embodied in the cap member in such a way that a symbol represented on or through the luminous area or projection area becomes visible for an operator of the control element by irradiating the symbol by means of a light source located on the switch side. The cap is characterized in that the luminous area or projection area encompasses a light-permeable metal coating which is preferably applied using a PVD process.

The challenge with a hidden-to-lit knob is the amount of light energy required for a pattern to light up effectively. Typically, a common metallic coating will absorb about 90% of the light energy provided by the back light sources to illuminate the knob. It would be desirable to deliver the light to the pattern and to the environment as efficiently as possible. Furthermore, rotational knobs need to maintain its mechanical functionality. Often there are springs, clips and other components behind the knob which can block the light from reaching the pattern. Non uniform light showing through pattern (hot and cold spots) is not acceptable in the market. Packaging to include a light source in a small knob can also be an issue. Customer wishes regarding functionality and attractiveness of an operator front panel of a device are not limited to whitegoods or consumer goods, but apply to all technical sectors in which products are manufactured with a certain demand on the design for the customer, such as the automotive industry.

### SUMMARY

In some example, the present disclosure describes providing an operating component for a device with hidden-to-lit pattern providing a good uniformity of light showing through the pattern where the light energy required for illuminating the pattern is used effectively and the operating component provides good mechanical functionality.

In an aspect, an operating component to operate a device includes a component body with a side face as well as a front face arranged on the component body and being suited for being at least partly illuminated by at least one light source, a light guide made of clear and transparent material and a reflector are arranged in the component body, with the light guide receiving light from the light source and directing the light to the reflector arranged underneath the front face, wherein the reflector is a diffuse reflector and is suitably shaped to direct the light received from the light guide to the front face, wherein the front face comprises a clear outer shell directed to an environment of the operating component and an opaque inner shell underneath the outer shell towards to the reflector, wherein the inner shell comprises at least one transparent area to transmit the light through the front face, and wherein the light guide extends from the light source as a pipe-like light channel towards the front face in a first section and in a second section the light guide expands in the shape of a cup with an edge bulging out with the light being guided along an axis of symmetry perpendicular to the front face into the component body. In particular the device can comprise a component body with a side face and a front face arranged on the component body, where a light source to illuminate at least parts of the front face, a light guide made of clear and transparent material and a reflector are arranged in the component body, the light guide receiving light from the light source and directing the light to the reflector arranged underneath the front face, the reflector is a diffuse reflector and is suitably shaped to direct the light received from the light guide to the front face, which comprises a clear outer shell directed to an environment of the operating component and an opaque inner shell underneath the outer shell towards to the reflector, where the inner shell comprises at least one transparent area to transmit the light through the front face, wherein the light source is arranged along an axis of symmetry perpendicular to the front face and the light guide extends from the light source as a pipe-like light channel along the axis of symmetry towards the front face in a first section and in a second section the light guide expands in the shape of a cup with an edge bulging out in the radial direction from the axis of symmetry.

The term “operating component” relates to any switch, control knob or operating equipment, where a user is able to switch on or off a certain functionality or adjust a certain functionality or operating level of a device comprising such operating component. The term “component body” relates to any sub-component of the operating component being arranged behind the front face with respect to the direction of view of the user onto the operating component. The term “front face” relates to the part of the operating component being visible to the user when installed in the device comprising such operating component. The light guide transmits light emitted from the light source to the front face for being emitted through the front face towards the user viewing the operating component. The reflector directs the light coming from the light guide through the front face, especially through the transparent areas of the inner shell of the front face. Due to the combination of transparent and opaque areas within the inner shell, the illumination of the inner shell leads to displaying illuminated pattern to the user, where the pattern may represent a decorative pattern, one or more icons for indicating certain functionality or for indicating a status of the operating component or the corresponding device. The terms “inner shell” and “outer shell” denote layers or a stack or sequence of layers forming a front face covering the component body. The front face might by flat or comprise a curvature. The “axis of symmetry” denotes an axis perpendicular to the front face, preferably through the geometrical center of the front face and/or preferably in form of a rotational axis, without being restricted thereto The perpendicular alignment of the axis of symmetry in particular refers to the tangent of a curved front face at the center of the front face, where the axis of symmetry is arranged. An example of the light guide having the shape of the cup with an edge bulging out in the radial direction from the axis of symmetry is given in FIG. 1. The term “pipe-like light channel” denotes any light guide section, where the diameter of the cross section perpendicular to the axis of symmetry of smaller than the extension of the light guide along the axis of symmetry. The pipe-like light channel according to the present invention may have of circular, oval, rectangular or differently shaped cross section perpendicular to the axis of symmetry. The size of the cross section might be constant or may vary along the axis of symmetry within the first section of the light guide. In order to provide a symmetric illumination, the light source is arranged in the axis of symmetry of the operating component. Therefore, the light guide and the reflector can be arranged occupying minimal space in the operating component enabling to provide operating components also in a compact arrangement when small sizes are required.

The specified shape of the light guide and the arrangement of the reflector with respect to the light guide and the front face enables to use the light provided by the light source effectively for illuminating the front face, which can be provided with different cross-sections, like in a circular, oval or rectangular shape. The possibility to light-up the operating component on demand and in a specific way determined by the transparent areas arranged in a desired pattern differentiate the operating component according to the present invention from other operating components according to prior art. The light guide might be made of clear and transparent PMMA material. The reflector might be made of white diffusing plastic material. The front face and the component body might be manufactured by 2K molding technology.

Therefore, the present invention provides an operating component for a device with hidden-to-lit pattern providing a good uniformity of light showing through the pattern where light energy required for illuminating the pattern is used effectively and the operating component provides good mechanical functionality.

In an embodiment the reflector framing at least an outer edge of the second section of the light guide radially to the axis of symmetry with a framing area. This shape of the reflector especially allows to occupy minimum space in the operating component.

In another embodiment the reflector is shaped to continue the contour of the second section of the light guide from the outer edge, where the reflector is bended towards the front face following the reflector in radial direction from the axis of symmetry. This shape of the reflector especially allows to illuminate the front face with even more effectivity and uniform light distribution. In a preferred embodiment the reflector therefore has a grooved contour to the front face.

In another embodiment the reflector covers at least the second section of the light guide on a side directing away from the axis of symmetry which is not directed towards the front face with a covering area ensuring to decrease loss of light in the light path from the light source to the front face.

In another embodiment the reflector comprises a step in its contour between the framing area and the covering area as a step area covering the outer edge of the light guide ensuring an effective outcoupling of light out of the light guide towards the reflector.

In another embodiment the edge bulging of the light guide comprises a peak point at a first radial distance to the axis of symmetry having a distance to the front face being smaller than the distance of the light guide at least at radial distances being larger than the first radial distance. Such a dome-like shape of the light guide in the second section ensures to reduce loss of lights in the light guide to its minimum while providing a good light outcoupling towards the reflector, while providing a light guide occupying minimum space within the operating component, and while providing a symmetric illumination of the front face with good uniform light distribution with the suitably shaped light guide and reflector.

In another embodiment the inner shell comprises multiple transparent areas in form of a pattern to transmit the light through the front face. The pattern might be shaped as icons to indicate a certain functionality of status to the user.

In another embodiment at least the front face is 2K molded using transparent polycarbonate for the outer shell and opaque polycarbonate, e.g. black polycarbonate, for the inner shell outside the transparent areas. In the transparent areas, also transparent polycarbonate might be used. In an alternative embodiment, the transparent areas might be transparent outcuts comprising no material. The polycarbonate material might be applied by PVD coating technologies, e.g. AST technology. The front face may comprise a surface texture with a stainless steel finish provided by the inner shell when not being illuminated. The inner shell might by a base hard coat. The opaque inner shell can also be provided by applying the pattern as an opaque coating on top of the inner shell base material, which can even be transparent in this case. In case of cutouts as the pattern, the cutouts might by manufactured e.g. by laser etching.

In another embodiment the light guide is made of clear and transparent PMMA and/or the reflector is made of diffusing plastic. The light guide made of this kind of material ensures light being directed in an efficient manner with minimal light wastage and maximum amount of light reaching the viewer. The reflector is diffused ensuring uniform light distribution with nearly no or no hot or cold light spots.

In another embodiment the operating component is adapted to be a rotatable component to be rotated around a rotational axis as the axis of symmetry, and/or the front face in rotationally symmetrical. To maintain consistent uniform lighting upon rotation of the operating component either the light source needs to be fixed in the center of the rotational axis or the light source needs to rotate with the rotatable component. The shape of the light guide and the reflector supports rotation of the operating component, since it is symmetrical around the rotational axis as the axis of symmetry. Therefore, in a preferred embodiment the operating component has a circular geometry with a cylindrical side face, where the front face is shaped as a circle, preferably being bended towards to the environment, where the reflector is shaped as a ring around the light guide, and where the edge bulging of the light guide is symmetrically shaped with a dome-like contour.

The light guide and the reflector may comprise features which assist in maintaining the mechanical rotational functions. Therefore, the component body may comprise clips on the back of the reflector for assembly of the light guide and sub-assemblies of the component body and/or the front face, and/or comprise ribs on the back of the reflector to ride on the component body providing friction for product haptics and/or a spout of the light guide is keyed and passes through a potentiometer to provide feedback on the rotational position of the operating component.

In another embodiment the light source is arranged at the rotational axis separately from a rotating part of the operating component, where at least the light guide, the reflector and the front face are part of the rotating part. In this case the light source can be fixed on a support or PCB, which makes power supply and control of the light source easier compared to an arrangement, where the light source have to be rotated together with the other parts of the operating component.

In another embodiment the light source is a solid state lighting source, preferably a LED or an array of LEDs. LEDs can provide colored light with different wavelengths within the visible spectrum. Also white light emitting LEDs are available. An array of LEDs is able to provide white light or light with a tunable wavelength depending on the control of individual red, green and/or blue LEDs in an array of LEDs.

In another embodiment the operating component further comprises a first capacitive switch, where a transmissive or transparent first conductive layer is applied on top of the outer shell of the front face suitably connected with a control unit detecting a first capacitive change in case of an object approaches the first conductive layer. The object can be a finger, a hand, a pen, a stick, a pointer or other suitable objects. The capacitance is established between the first conductive layer, which is connected to ground via the control unit and the object, which has also an electrical connecting to ground. The finger in vicinity or direct contact to the first conductive layer changes the capacity established by this system relative to ground, which is detected by the control unit as a corresponding trigger signal to initiate a corresponding response (e.g. performing a certain functionality of the first capacitive coupling switch). The first conductive layer can be connected to the control unit via so-called 4-point contacting made on the outer areas or edges of the first conductive layer. The first conductive layer might by a conductive PVD layer, e.g. an ITO layer or a layer of conducting plastics or a conductive foil or a layer of conductive ink.

Companies are continually seeking ways to further incorporate new technologies for brand differentiation. Therefore, seamless decorative metallic surfaces which light up when being touched are becoming more desirable in domestic, building, appliances and automotive applications. For example, a user might touch an exterior car door handle which light up advising the lock is open, a user might touch a control knob on a food processor which lights up to advise the user the unit it on, a user might touch the volume up button on a radio which changes color as the volume goes up, and/or a user might touch an automotive interior component and mood lighting of that component comes on. In an embodiment the control unit is adapted to switch on the light source to illuminate pattern provided by the front face. In a preferred embodiment the conductive layer covers the entire outer shell of the front face. As long as the pattern are not illuminated, the first capacitive coupling layer can be touched at any position to change the capacitance in order to cause a triggering signal for the control unit.

In another embodiment the operating component further comprises at least one second capacitive switch only covering at least some of the transparent areas of the front face being illuminated after having switched on the light of the light source by the first capacitive switch, preferably a plurality of second conductive switches are covering each of the transparent areas as separate second conductive switches. This combination of first and second capacitive switches provides a one-touch operating panel with a particular aesthetic appearance. In the off-state only a metallic surface, e.g. provided by the inner shell, is visible to the user. After switching the first capacitive switch, e.g. by touching the front face of the operating component (here the first conductive layer), the operating component will be illuminated making the before hidden second capacitive switches now being visible to the user, which are arranged behind the illuminated pattern, where each pattern correspond to one second capacitive switch arranged at the position of the illuminated pattern or icon. When touching again the front face of the operating component at the position of the illuminated pattern or icon, the corresponding second capacitive switch will be activated resulting in a functionality assigned to this second capacitive switch by the control unit. In another embodiment the control unit is adapted to initiate another function in response to detecting the second capacitive change of the second capacitive switch.

Therefore in another embodiment the inner shell comprises a stack of layers establishing the second capacitive switch, the stack comprising a bendable layer on top of an opaque mask comprising the transparent areas of the front face, where the transparent areas are established by cutouts in the opaque mask, where a transmissive or transparent second conductive layer is arranged underneath the opaque mask at least covering the cutouts, where a second capacitive change between first and second conductive layers is detected by the control unit where bending the bendable layer at least in the vicinity of the cutouts by applying a force to the front face in the vicinity of the illuminated cutouts. The bending layer provides a haptic switching functionality preferred by users to these decorative parts, when a user is touching the part in or around the illuminated surface. The bendable layer might be made of polycarbonate, the material suitable to provide the opaque mask are described before when discussing the inner shell and the second conductive layer might be made of the same material as described for the first conductive layer or use different transparent material.

In another embodiment a protective or decorative coating is applied on top of the first conductive layer at least to protect the first conductive layer ensuring its reliability.

In another aspect, a device includes at least one operating component as described. The device may include only one of such operating component or may include an operating panel comprising multiple of such operating components. In an embodiment, the device is a whitegoods device, consumer goods device or an operator panel in a vehicle.

### BRIEF DESCRIPTION OF THE DRAWINGS

The following drawings show aspects of the invention for improving the understanding of the invention in connection with some exemplary illustrations, wherein

FIG. 1 shows an embodiment of the operating component according to the present invention (a) in perspective view and (b) in a side view;

FIG. 2 shows another embodiment of the operating component in perspective view for (a) being non-illuminated and (b) being illuminated;

FIG. 3 shows another embodiment of the front face in perspective view from the inner side of the front face;

FIG. 4 shows another embodiment of the operating component according to the present invention comprising first and second capacitive switches;

FIG. 5 shows another embodiment of the operating component of FIG. 4 in a side view.

### DETAILED DESCRIPTION

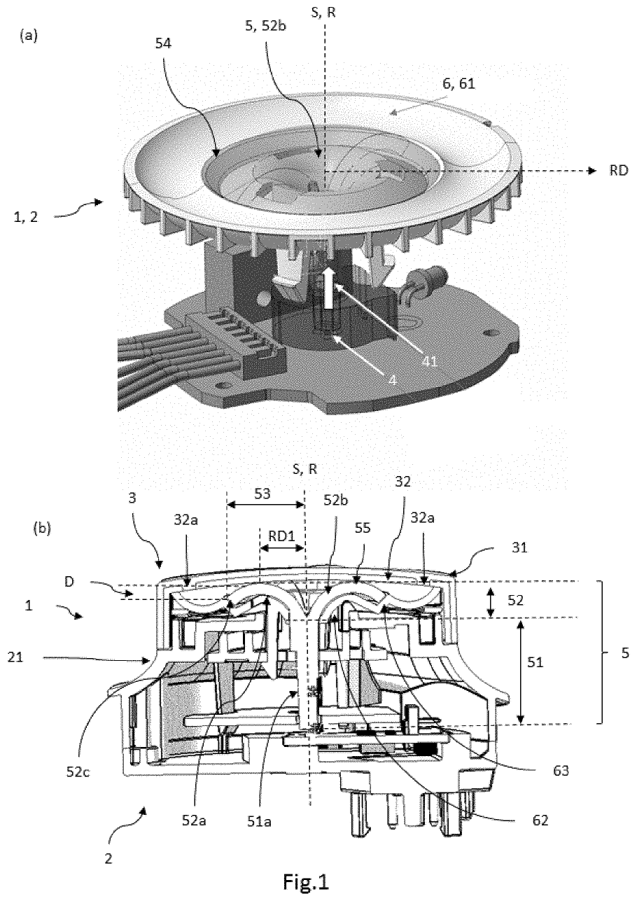

FIG. 1 shows an embodiment of the operating component 1 according to the present invention to operate a device 100 (a) in perspective view and (b) in a side view comprising a component body 2 with a side face 21 and a front face 3 arranged on the component body 2. The operating component 1 comprises a light source 4 to illuminate at least parts of the front face 3. The light source 4 might be a solid state lighting source, preferably a LED or an array of LEDs. The operating component 1 further comprises a light guide 5 made of clear and transparent material, e.g. PMMA, and a reflector 6 are arranged in the component body 2 made of diffusing plastic. The light guide 5 receives light 41 from the light source 4 and directs the light 41 to the reflector 6 arranged underneath the front face 3. Therefore, the light guide 5 extends from the light source 4 as a pipe-like light channel along the axis of symmetry S towards the front face 3 in a first section 51 and in a second section 52 the light guide 5 expands in the shape of a cup with an edge bulging 53 out in the radial direction RD from the axis of symmetry S. Here the edge bulging 53 comprises a peak point 55 at a first radial distance RD1 to the axis of symmetry S having a distance to the front face being smaller than the distance D of the light guide 4 at least at radial distances RD being large than the first radial distance RD1. The reflector 6 is a diffuse reflector and is suitably shaped to direct the light 41 received from the light guide 5 to the front face 3. The reflector 6 frames the outer edge 54 of the second section 52 the light guide 5 radially to the axis of symmetry S with a framing area 61. The reflector 6 is shaped to continue the contour of the second section 52 of the light guide 5 from the outer edge 54, where the reflector 6 is bended towards the front face 3 following the reflector 6 in radial direction RD from the axis of symmetry S, here the reflector 6 has a grooved contour to the front face 3. The reflector 6 covers the second section 52 of the light guide 5 on a side 52a directing away from the axis of symmetry S which is not directed towards the front face 3 with a covering area 62. The reflector may continue covering also at least parts of the surface 51a of the first section 51 of the light guide 5. The reflector 6 comprises a step in its contour between the framing area 61 and the covering area 62 as a step area 63 covering the outer edge 54 of the light guide 5. The front face comprises a clear outer shell 31 directed to an environment of the operating component 1 and an opaque inner shell 32 underneath the outer shell 31 towards to the reflector 6, where the inner shell 32 comprises one transparent area 32a shaped as a ring around the axis of symmetry to transmit the light 41 through the front face 3, wherein the light source 4 is arranged along an axis of symmetry S perpendicular to the front face 3. The inner shell 32 may also comprise multiple transparent areas 32a in form of a pattern to transmit the light 41 through the front face 3.

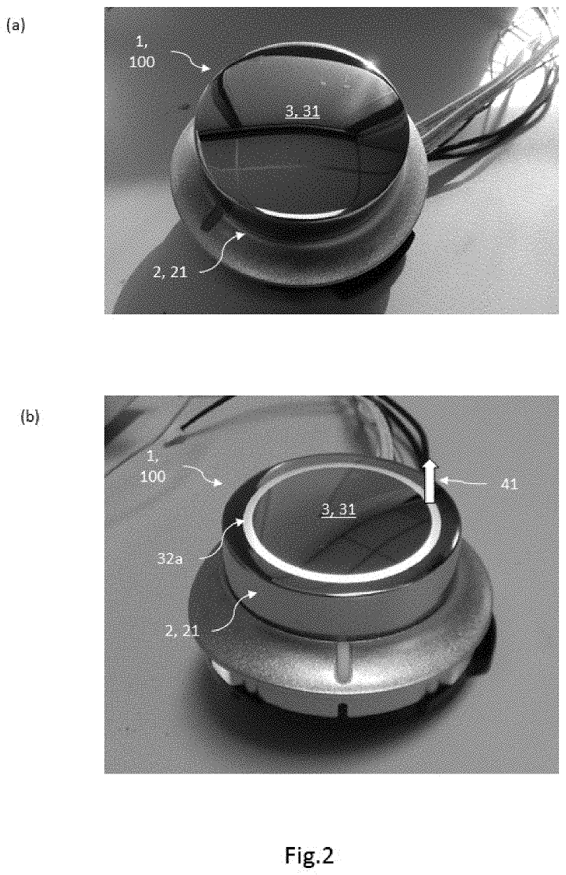

FIG. 2 shows another embodiment of the operating component 1 or a device 100 in perspective view for (a) being non-illuminated and (b) being illuminated. The operating component 1 is adapted to be a rotatable component to be rotated around a rotational axis R as the axis of symmetry S (not explicitly shown here, see FIG. 1). The operating component 1 has a circular geometry with a cylindrical side face 21, where the front face 3 is shaped as a circle and bended towards to the environment, where the reflector 6 is shaped as a ring around the light guide 5, and where the edge bulging 53 of the light guide 5 is symmetrically shaped with a dome-like contour. The light source 4 is arranged at the rotational axis separately from a rotating part of the operating component 1, where at least the light guide 5, the reflector 6 and the front face 3 are part of the rotating part. The device 100 (not explicitly shown here) comprises at least one operating component 1 according to the present invention. The device might be a whitegoods device, consumer goods device or an operator panel in a vehicle.

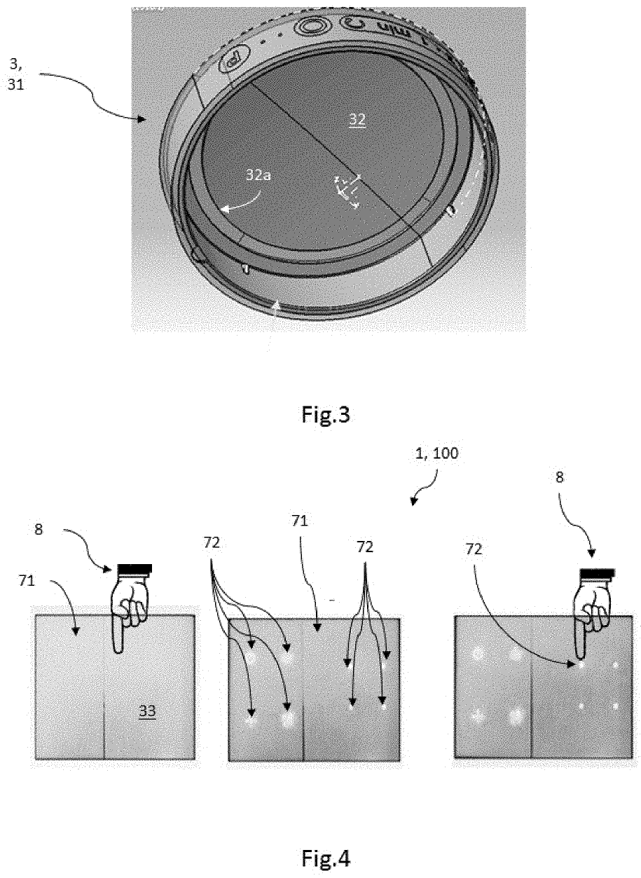

FIG. 3 shows another embodiment of the front face 3 in perspective view from the inner side of the front face 3. The front face 3 comprises an outer shell 31 and an inner shell 32. The inner shell 32 comprises transparent areas 32a in form of a ring to transmit the light 41 through the front face 3. At least the front face 3 might be 2K molded using transparent polycarbonate for the outer shell 31 and opaque polycarbonate for the inner shell 32 outside the transparent areas 32a.

FIG. 4 shows another embodiment of the operating component 1 or a device 100 according to the present invention comprising first and second capacitive switches 71, 72. The operating component 1 comprises a first capacitive switch 71, where a transmissive or transparent first conductive layer 33 is applied on top of the outer shell 31 of the front face 3 suitably connected with a control unit 73 detecting a first capacitive change CC in case of an object 8, preferably a finger 8, approaches the first conductive layer 33. The control unit 73 is adapted to switch on the light source to illuminate at least pattern provided by the front face 3. The conductive layer 33 covers the entire outer shell 31 of the front face 3. The operating component 1 further comprises at least one second capacitive switch 72 only covering at least some of the transparent areas 32a of the front face 3 being illuminated after having switched on the light 41 of the light source 4 by the first capacitive switch 71, preferably a plurality of second conductive switches 72 are covering each of the transparent areas 32a as separate second conductive switches 72.

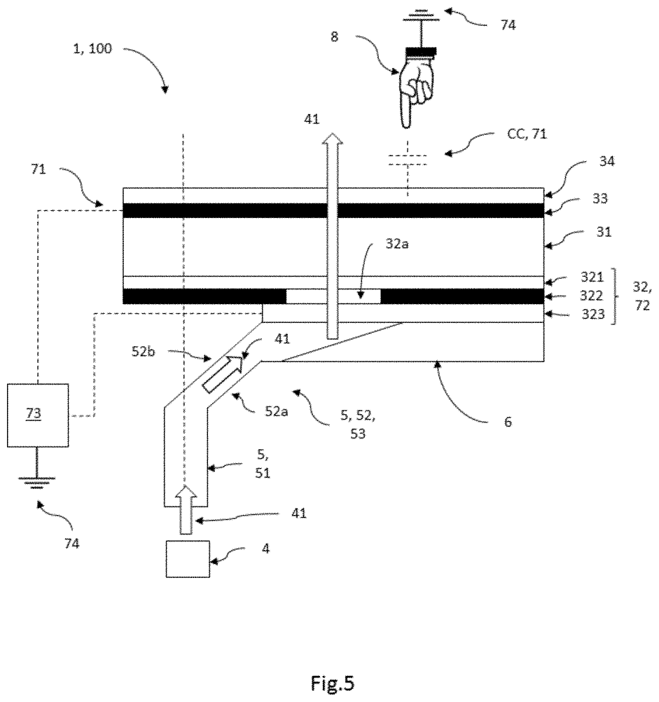

FIG. 5 shows another embodiment of the operating component 1 of FIG. 4 in a side view.

The operating component 1 comprises a first capacitive switch 71, where a transmissive or transparent first conductive layer 33 is applied on top of the outer shell 31 of the front face 3 suitably connected with the control unit 73 detecting a change of a first capacity CC between an object 8, here a finger 8, and the first conductive layer 33 in case of the finger 8 approaches the first conductive layer 33. The first conductive layer 33 is grounded 74 via the control unit 73 while the finger 33 is grounded 74 by the user standing or sitting somewhere. Here the inner shell 32 further comprises a stack of layers 321, 322, 323 establishing the second capacitive switch 72, the stack comprising a bendable layer 321 on top of an opaque mask 322 comprising the transparent areas 32a of the front face 3, where the transparent areas 32a are established by cutouts in the opaque mask 322, where a transmissive or transparent second conductive layer 323 is arranged underneath the opaque mask 322 at least covering the cutouts 32a, where a second capacitive change between first and second conductive layers 33, 323 is detected by the control unit 73 where bending the bendable layer 321 at least in the vicinity of the cutouts 32a by applying a force to the front face 3 in the vicinity of the illuminated cutouts 32a. The control unit 73 is adapted to initiate another function in response to detecting the second capacitive change of the second capacitive switch 72. A protective or decorative coating 34 is applied on top of the first conductive layer 33.

The features disclosed in the claims, the specification, and the drawings maybe essential for different embodiments of the claimed invention, both separately or in any combination with each other.

### REFERENCE NUMERALS

1 operating component according to the present invention
2 component body
21 side face of the operating component
3 front face
31 outer shell
32 inner shell
32a transparent area(s) of the inner shell
321 bendable layer
322 opaque mask
323 second conductive layer
33 first conductive layer
34 protective or decorative coating
4 light source
41 light from the light source
5 light guide
51 first section of the light guide
51a surface of the first section
52 second section of the light guide
52a side of the second section
52b side of the second section
52c end face of the light guide in the second section
53 edge bulging
54 outer edge of the light guide in the second section
55 peak point
6 reflector
61 framing area
62 covering area
63 step area
71 first capacitive switch
72 second capacitive switch
73 control unit
74 connection to ground
8 object (e.g. a finger)
100 device according to the present invention
CC capacitance change
D distance between light guide and front face
R rotational axis
RD radial direction
RD1 first radial distance
S axis of symmetry

What is claimed is:

1. An operating component to operate a device, comprising:
a component body with a side face and as a front face arranged on the component body and being suited for being at least partly illuminated by at least one light source;
a light guide made of clear and transparent material; and
a reflector arranged in the component body, with the light guide receiving light from the light source and directing the light to the reflector arranged underneath the front face,
wherein the reflector is a diffuse reflector and is suitably shaped to direct the light received from the light guide to the front face,
wherein the front face comprises a clear outer shell directed to an environment of the operating component and an opaque inner shell underneath the outer shell towards the reflector,
wherein the inner shell comprises at least one transparent area to transmit the light through the front face, and
wherein the light guide extends from the light source as a pipe-like light channel towards the front face in a first section and, in a second section, the light guide expands in the shape of a cup with an edge bulging out with the light being guided along an axis of symmetry perpendicular to the front face into the component body.

2. The operating component according to claim 1, wherein at least one of
the light source is arranged along the axis of symmetry, or
the first section of the light guide extends along the axis of symmetry with the second section of the light guide expanding out in the radial direction from the axis of symmetry.

3. The operating component according to claim 1, wherein the reflector frames at least an outer edge of the second section of the light guide radially to the axis of symmetry with a framing area.

4. The operating component according to claim 3, wherein the reflector is shaped to continue the contour of the second section of the light guide from the outer edge, and
wherein at least one of the reflector is bent towards the front face following the reflector in radial direction from the axis of symmetry or the reflector has a grooved contour to the front face.

5. The operating component according to claim 1, wherein the reflector covers at least the second section of the light guide on a side directing away from the axis of symmetry which is not directed towards the front face with a covering area.

6. The operating component according to claim 5, wherein the reflector comprises a step in its contour between the framing area and the covering area as a step area covering the outer edge of the light guide.

7. The operating component according to claim 1, wherein the edge bulging of the light guide comprises a peak point at a first radial distance to the axis of symmetry having a distance to the front face being smaller than the distance of the light guide at least at radial distances being larger than the first radial distance.

8. The operating component according to claim 1, wherein the inner shell comprises multiple transparent areas in form of a pattern to transmit the light through the front face.

9. The operating component according to claim 1, wherein at least one of
one or more of at least the front face is 2K molded using transparent polycarbonate for the outer shell and opaque polycarbonate for the inner shell outside the transparent areas, or the light guide is made of clear and transparent PMMA, or
the reflector is made of diffusing plastic.

10. The operating component according to claim 1, wherein at least one of
the operating component is adapted to be a rotatable component to be rotated around a rotational axis as the axis of symmetry, or
the front face is rotationally symmetrical.

11. The operating component according to claim 10, wherein the operating component has a circular geometry with a cylindrical side face, and
wherein the front face has a circular cross-section with the front face being shaped as a circle being bent towards the environment.

12. The operating component according to claim 10, wherein the reflector is shaped as a ring around the light guide, with the edge bulging of the light guide being symmetrically shaped with a dome-like contour.

13. The operating component according to claim 10, wherein the light source is arranged at the rotational axis separately from a rotating part of the operating component, and
wherein at least the light guide, the reflector, and the front face are part of the rotating part.

14. The operating component according to claim 1, wherein the light source is a solid state lighting source including a LED or an array of LEDs.

15. The operating component according to claim 1, wherein the operating component further comprises a first capacitive switch, and
wherein a transmissive or transparent first conductive layer is applied on top of the outer shell of the front face suitably connected with a control unit detecting a first capacitive change in case of an object or a finger approaching the first conductive layer.

16. The operating component according to claim 15, wherein the control unit is adapted to switch on the light source to illuminate a pattern provided by the front face.

17. The operating component according to claim 16, wherein the conductive layer covers the entire outer shell of the front face.

18. The operating component according to claim 15, wherein the operating component further comprises at least one second capacitive switch only covering at least some of the transparent areas of the front face being illuminated after having switched on the light of the light source by the first capacitive switch, and a plurality of second conductive switches are covering each of the transparent areas as separate second conductive switches.

19. The operating component according to claim 18, wherein the inner shell comprises a stack of layers establishing the second capacitive switch, the stack comprising a bendable layer on top of an opaque mask comprising the transparent areas of the front face,
wherein the transparent areas are established by cutouts in the opaque mask,
wherein a transmissive or transparent second conductive layer is arranged underneath the opaque mask at least covering the cutouts,
wherein a second capacitive change between first and second conductive layers is detected by the control unit, and
wherein the bendable layer bends at least in the vicinity of the cutouts by applying a force to the front face in the vicinity of the illuminated cutouts.

20. The operating component according to claim 19, wherein the control unit is adapted to initiate another function in response to detecting the second capacitive change of the second capacitive switch.

21. The operating component according to claim 15, wherein a protective or decorative coating is applied on top of the first conductive layer.

22. A device, comprising at least one operating component according to claim 1, the device being a whitegoods device, consumer goods device, or an operator panel in a vehicle.
